(19) United States
(12) Patent Application Publication
(10) Pub. No.: US 2024/0330909 A1
(43) Pub. Date: Oct. 3, 2024

(54) HIGH-SECURITY TOGGLE SYSTEM FOR PAYMENT INSTRUMENT DISPLAY

(71) Applicant: Bank of America Corporation, Charlotted, NC (US)

(72) Inventors: Nicole Guereque, Chandler, AZ (US); Matthew Dana Murphy, Charlotte, NC (US); Jeetendra Hukmichand Jain, Charlotte, NC (US); Bradley Ryan Holland, Bellingham, WA (US); Nathanael Richard Lindsay, Westfield, IA (US); Steven M. Twombly, Saco, ME (US); Willis Marley Clow, Salt Lake City, UT (US)

(21) Appl. No.: 18/129,148

(22) Filed: Mar. 31, 2023

(51) Int. Cl. G06Q 20/38; G06Q 20/36; G06Q 20/40

(52) U.S. Cl. CPC G06Q 20/382; G06Q 20/36; G06Q 20/401

(57) ABSTRACT

Systems, methods, and apparatus are provided for a high-security display of distinct subsets of a digital payment card dataset. A payment card issuer may import token data to generate a digital payment card for a user. In some embodiments, the digital payment card may include the token place of a payment card PAN, a token expiration date in place of a payment card expiration date, and a token security code in place of a card CVV. The user may access the digital payment card data at a high security display that toggles to different subsets of the payment card dataset. The display may require different levels of verification to access each subset of the dataset. The user may execute a transaction using the digital payment card data.

### FIELD OF TECHNOLOGY

Aspects of the disclosure relate to electronic displays. Specifically, aspects of the disclosure relate to high-security electronic displays with multiple modes.

### BACKGROUND OF THE DISCLOSURE

Computer-based display of payment card data may put sensitive data at risk. While a physical card may be secured based on possession of the card by the user, digital card data is more vulnerable to bad actors. Sensitive data may include account numbers, expiration dates, and card verification values (“CVV”). Data may be accessed for display via a website, computer program, mobile application, or any suitable display. Mobile applications may include banking applications or other financial applications, such as digital wallets.

In many cases, digital display of payment card information requires that a user have access to a physical payment card. It would be desirable to provide access to digital payment card data immediately upon issue, even before a physical payment card arrives. It would be desirable to secure the digital payment card data to shield it from access by bad actors.

### SUMMARY OF THE DISCLOSURE

Systems, methods, and apparatus are provided for a high-security display of distinct subsets of a digital payment card dataset.

A payment card issuer may import token data. The token data may include a token generated from a primary account number (PAN). The token may have the same number of digits as the PAN. The token data may include an expiration date associated with the token. The token data may include a token security code associated with the token.

The payment card issuer may generate a digital payment card for a user. The digital payment card may include the token in place of a payment card PAN, the token expiration date in place of a payment card expiration date, and the token security code in place of a card CVV. The user may execute transactions by entering the digital payment card data.

The user may access the digital payment card data at a high security display. In response to receiving a first signal from the user, a verification status may be upgraded from a default security level to a first security level. When the verification status is at the first security level, the user may access a first subset of the digital payment card dataset.

In response to a second signal from the user, the verification status may be upgraded from the first security level to a second security level. When the verification status is at the second security level, the display may be augmented with the ability to toggle to a second subset of the digital payment card dataset.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows another illustrative system in accordance with principles of the disclosure;

FIG. 3 shows an illustrative flowchart in accordance with principles of the disclosure;

FIG. 4 shows an illustrative screen view in accordance with principles of the disclosure;

FIG. 5 shows an illustrative screen view in accordance with principles of the disclosure;

FIG. 6 shows an illustrative screen view in accordance with principles of the disclosure;

FIG. 7 shows an illustrative screen view in accordance with principles of the disclosure;

FIG. 8 shows an illustrative screen view in accordance with principles of the disclosure;

FIG. 9 shows a prior art process flow;

FIG. 10 shows an illustrative process flow in accordance with the principles of the invention;

FIG. 11 shows a set of illustrative scenarios in accordance with the principles of the invention;

FIG. 12 shows a set of illustrative screen views in accordance with the principles of the invention; and

FIG. 13 shows an illustrative process flow in accordance with the principles of the invention.

### DETAILED DESCRIPTION OF THE DISCLOSURE

Systems, methods, and apparatus are provided for a digital payment card display with a high-security interface. A toggle-enabled user interface (“TUI”) may display distinct subsets of a dataset. The dataset may include information associated with the digital payment card. The TUI may require multiple levels of verification before enabling access to a display that includes sensitive portions of the dataset.

The digital payment card may be a digital debit card, digital credit card, or any suitable digital payment instrument.

The TUI may include a display. The display may be viewed on a screen associated with a computing device such as a desktop, laptop, mobile device, wearable device, or any suitable device.

The TUI may include a verification module configured to receive a plurality of signals. The verification module may establish a level of verification status. In response to a first signal, the verification module may upgrade the verification status from a default level to a first level. When the verification status is at the first level, the display may include a first subset of the dataset.

In response to a second signal, the verification module may upgrade the verification status from the first level to a second level. When the verification status is at the second level, the display may be augmented with the ability to toggle to a second subset of the dataset. The second subset of the dataset may include sensitive information. The second portion of the dataset may be displayed together with the first portion of the dataset.

In some embodiments, toggling the screen to display the second subset of the dataset may be automatic. For example, when the verification status is upgraded to the second level, the display may show the second subset independent of any user input. In some embodiments, even when the verification status has been upgraded to the second level, the display may include the second subset of the dataset only in response to a user input, such as selection of an option. The selection may be touch-based, voice-based, gesture-based or may involve any suitable form of input. Touch-based selection may include pressing a button, clicking an icon, or any suitable manner of selecting an option.

The TUI may be associated with a mobile application on a mobile device. The mobile device may require a default verification level to authenticate the user. A user may perform a first action that qualifies as a first signal. The first signal may establish a first verification level and enable access to the mobile application. The mobile application may display a portion of a dataset. The user may perform a second action that qualifies as a second signal. The second signal may establish a second verification level which unlocks a second, sensitive, portion of the dataset. The display may toggle to the second, sensitive, portion of the dataset. In some embodiments, the user may toggle the display back and forth between the two portions of the dataset.

The first signal may include input of a password. The first signal may include input of a personal identification number (“PIN”). The first signal may include a biometric input, such as a fingerprint, retina scan, heartbeat or pulse, voiceprint, facial scan, or any suitable biometric input.

In some embodiments, the first signal may establish trusted user access. For example, if a user input successfully upgrades the verification status to the first level, the input may no longer be required on subsequent attempts to access the first subset of the dataset.

The second signal may include input of a password. The second signal may include input of a personal identification number (“PIN”). The second signal may include a biometric input. In some embodiments, the second signal may include input of a temporary passcode. The passcode may be transmitted to the user device as part of a two-step authentication protocol. For example, a user may enter a password to access a mobile application and reach the first verification level. In order to access the second, sensitive, subset of the dataset, the user may be required to enter a temporary passcode to reach the second verification level. The temporary passcode may be formulated for a single access session. The temporary passcode may be texted, emailed, or otherwise transmitted to a verified account or device associated with the user.

In some embodiments, the dataset may include a sequence of numbers associated with a digital payment card. The sequence of numbers may include a 16-digit account number associated with the digital payment card. The sequence of numbers may also include an expiration date associated with the digital payment card, and a CVV associated with the digital payment card. The CVV may be formulated at least in part based on the expiration date. The term CVV as used herein may be synonymous with CVV2.

In some embodiments, the first subset of the dataset may include the last 4 digits of a 16-digit account number associated with a digital payment card. The first subset of the dataset may include an expiration date associated with the digital payment card and/or a CVV associated with the digital payment card.

In some embodiments, the second subset of the dataset may include all the digits of a 16-digit account number associated with the digital payment card. The second subset of the dataset may include an expiration date associated with the digital payment card and/or a CVV associated with the digital payment card.

The data displayed in the second subset of the dataset may be used for executing a transaction. For example, a user may be able to enter information contained in the second subset at an online merchant to execute a purchase. A user may be able to enter the data to access an account at an online banking portal or cardless ATM. A user may also be able to enter the data to provision a digital wallet.

### Temporary Digital Payment Card

In some embodiments, the digital payment card may be a temporary payment card associated with a newly issued physical payment card. The temporary digital payment card may have the same account number and/or CVV as the physical payment card. The temporary digital payment card may have a different account number and/or CVV than the physical payment card.

A TUI display for a temporary digital payment card may be accessed substantially immediately after the physical payment card is issued. In some embodiments, the temporary digital payment card may be available any time prior to receipt and activation of the physical payment card.

The temporary digital payment card may be replaced when a user comes into possession of a physical payment card. The temporary digital payment card may have an expiration date that is earlier than expiration date of the physical payment card. The expiration date of the temporary digital payment card may be a predetermined time span following creation of the physical payment card.

The temporary digital payment card may be deactivated when the physical payment card is activated. In some embodiments, the physical payment card may be periodically or substantially continuously monitored for activation. For example, the physical payment card may be monitored once a day. The monitoring may coincide with batch processing activity. In another example, the status of the physical payment card may be monitored each time a user accesses the temporary digital payment card. In another example, an alert may be issued when the physical payment card is activated.

### Independent Digital Payment Card

In some embodiments, the digital payment card may function independently of the physical payment card. The digital payment card data may be derived from data associated with the physical payment card. The digital payment card data may be derived using tokenization protocols.

Tokens are typically created during a transaction to protect sensitive customer data such as an account number, by replacing it with a series of algorithmically generated numbers and letters. Sensitive information associated with a financial account may include a primary account number (“PAN”). Sensitive information may include a card expiration date. Sensitive information may include a CVV.

The PAN is a typically multi-digit number printed on a front face of a payment card. The PAN may identify an issuer bank associated with the payment card. The PAN may identify a user account at the issuer bank. The PAN may be known as a funding PAN (“FPAN”) to distinguish it from tokenized versions of the PAN.

In a conventional token transaction, a merchant or digital wallet may receive an FPAN, CVV, and card expiration date from a user and request a tokenized account number from a payment processor. A payment processor gateway may generate a token from the FPAN. The token may be randomly generated through non-reversible mathematical algorithms. Multiple tokenized versions may map back to a single FPAN without the owner being aware of it. The payment gateway may maintain a secure vault to store the FPAN.

Token requesters, such as a merchant or digital wallet, may use and/or store the tokenized account number. The tokenized account number may be transmitted to the merchant acquiring bank, which may transmit the token to a payment processing network for authorization. The payment processing network may transmit a PAN-based authorization request with the token data appended to the message to the issuer for approval.

Conventionally, a payment card user will not be aware of the tokenization process. The user inputs their actual card data including an FPAN and CVV. Tokenization occurs later, during payment processing to shield the information from transaction party networks.

Improvements to tokenization architecture may enable the payment card issuer bank to become a token requestor. The new architecture may leverage features of the tokenization process to improve digital payment card security and life-cycle management.

The issuer bank may access third-party payment processor tokenization services to create a token from an FPAN. In this scenario, the issuer bank becomes both the token requestor and, later in the authorization process, the token recipient.

When the issuer bank is a token requestor, it may hold both the FPAN and the token. The issuer bank may expose the token data to the customer as digital payment card data. The tokenized version of the FPAN may become the payment card number. The token expiration may become the payment card expiration date. A token security code associated with token security may stand in for a CVV.

The user may use the digital payment card containing the tokenized information to execute a transaction or for any suitable purpose. During a transaction, the payment processor that created the token may map the token to the FPAN to authorize the transaction.

The expiration date for the digital payment card may also be derived from the tokenization protocols. The expiration date for the digital payment card may be based on the token expiration date.

In some embodiments, the token may be a multi-use token. The digital payment card may include the same number every time the customer accesses the card for a payment. In some embodiments, the digital payment card may include the same tokenized PAN for a predetermined number of uses or a predetermined time period. However, even if the token is intended to be a multi-use token, it may be reissued in response to a fraud alert.

In some embodiments, the token may be a single-use token. The digital payment card may include a different number every time the customer accesses the card.

The CVV for the digital payment card may also be derived from tokenization protocols. A dynamic security code may be generated by leveraging elements of the tokenization process.

As part of a typical tokenization process, a token requestor obtains a token security code from the payment processing network. The token requestor uses the security code in conjunction with the token for verification The token security code may be a cryptogram. Because conventional tokenization protocols occur only after the user has submitted the FPAN and CVV, this security code is never exposed to the user.

As set forth above, when the issuer bank is the token requestor, the token may be provided to a customer to use as a digital payment card PAN. When a user accesses the digital card, it may trigger a background call between the issuer bank and the payment processing network to request a token security code. The code may be valid for a single transaction, for a predetermined time period, or for a predetermined number of transactions.

As set forth above, on the digital payment card issued to the user, the token may stand in for the FPAN and the token expiration date may stand in for the payment card expiration date. Similarly, the token security code may stand in for the CVV. The dynamic nature of the token security code adds an extra layer of protection to the digital payment card. In a conventional transaction, the user does not have access to any of the token data. By converting the issuer to a token requestor, the digital payment card may include all these elements for use by a customer.

The digital payment card thus includes multiple security features. First, sensitive data is never transmitted to a merchant. Instead of providing an actual FPAN or CVV to a merchant or digital wallet, the customer enters the tokenized data, reducing the risk of exposure for sensitive data.

Second, because the digital payment card data functions independently of the FPAN, the digital payment card number may be changed without impacting the underlying account number. If the digital payment card is compromised, the payment processing network can update token credentials, allowing the issuer bank to instantly reprovision the digital payment card.

Third, the token security code that stands in for a CVV may change after each use. The dynamic digital security code may be especially useful in combination with the verification requirements of the TUI. Because the digital code is dynamic and must be obtained for each transaction, it cannot be compromised through prior exposure. Because of the multi-level verification associated with the TUI, it also cannot be accessed during use except by an authorized user.

In some embodiments, the token may also be bound to a specific device so that anomalies between token use, physical devices, and geographic locations may be flagged as potentially fraudulent.

The digital payment card may be accessed through an mobile device application associated with the issuer bank. The mobile application may include functions that enable control of the digital payment card, such as the ability to lock, unlock, or delete the card. In some embodiments, a user may be able to select how often the digital payment card PAN or token security code is replaced. Because the digital payment card functions independently of physical payment card, if the digital payment card is locked, the physical payment card may still be used for transactions. Likewise, if the physical payment card is locked, the digital payment card may still be used for transactions.

The mobile application may include a feature that functions as a digital wallet. The digital wallet may be provisioned with digital payment cards created by the issuer bank. When a new token is issued, an updated digital payment card may automatically replace the digital payment card in the mobile application digital wallet.

In the case where a digital payment card is a temporary version of a physical payment card, the temporary digital payment card may be stored in an issuer system of record as a separate entry. The user may have two payment card records, one listed as active and one as inactive. When the physical payment card is activated, the entry for the temporary digital payment card may be deleted.

In the case where the digital payment card data functions independently of the physical payment card using token data, a single entry for the user FPAN may be maintained in the system of record. A physical payment card may be issued with the FPAN. Digital payment cards using the tokenized FPAN data may be associated with the same record and may be activated or deleted without affecting the database entry.

The digital payment card may be used to provision a third-party digital wallet. A third-party digital wallet may not be provided by the card issuer. Examples of digital wallets include mobile payment services Apple Pay™, by Apple Inc., Cupertino, CA and Google Pay™, by Google LLC, Menlo Park, CA.

Third-party digital wallets may function as token requestors. Conventionally, a user may enter their FPAN and CVV and the digital wallet secures a token to avoid exposing the customer data during processing. In the case of a digital payment card that is derived from an issuer token, the system may be configured to support a token for token request. The digital wallet may not be aware of receiving a tokenized account number in place of the FPAN and a token security code in place of a CVV. The payment processor may return a second token to the wallet in place of the data. When the digital wallet is used for a transaction, the payment processor may convert this second token back to the FPAN to secure issuer approval.

One or more non-transitory computer-readable media storing computer-executable instructions are provided. When executed by a processor on a computer system, the instructions may perform a method for a high-security display of distinct subsets of a digital payment card dataset.

The method may include, at a payment card issuer, importing token data. The token data may include a tokenized PAN that is generated from an FPAN. The tokenized PAN may have the same number of digits as the FPAN.

The token data may include an expiration date associated with the tokenized PAN. The token data may include a token security code associated with the tokenized PAN.

The method may include issuing a digital payment card for a user. The digital payment card may include the tokenized PAN in place of an FPAN, the token expiration date in place of a card expiration date, and the token security code in place of the CVV. The user may execute a transaction by entering the token data.

The method may include, at a high security display, in response to receiving a first signal from a user, upgrading a verification status from a default security level to a first security level. The method may include, when the verification status is at the first security level, displaying a first subset of the digital payment card dataset to the user.

The method may include, in response to a second signal, upgrading the verification status from the first security level to a second security level. The method may include, when the verification status is at the second security level, augmenting the display with a selectable option to toggle to a second subset of the dataset.

In some embodiments, the first signal may include correct entry of a password. In some embodiments, the second signal may include correct entry of a one-time passcode that was transmitted to a device for two-step authentication.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

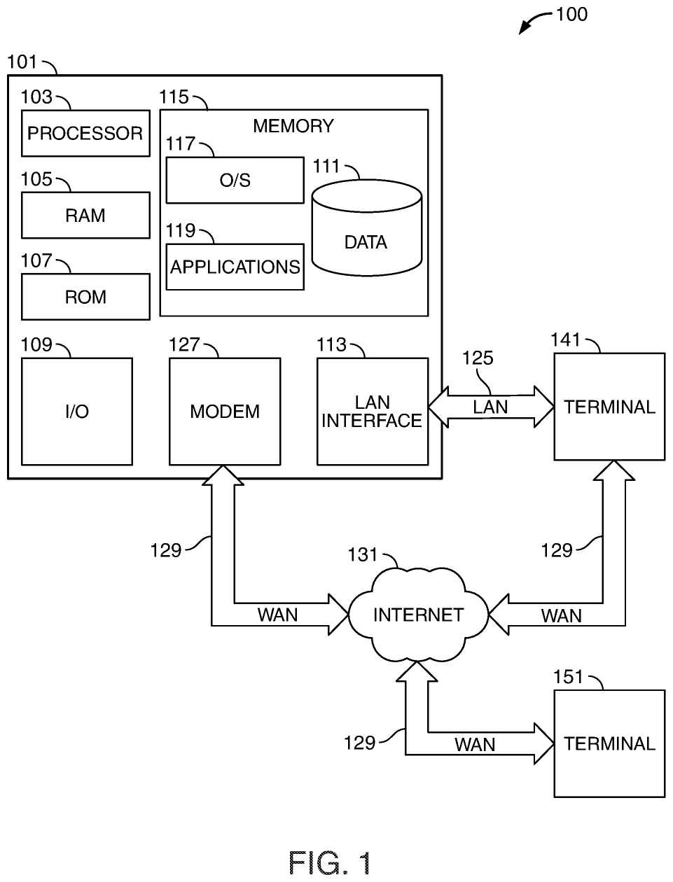

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of the computer 101.

Memory 115 may be comprised of any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. The computer executable instructions may be embodied in hardware or firmware (not shown). Application program(s) 119 may utilize one or more algorithms that process received executable instructions, perform power management routines or other suitable tasks. Application program(s) 119 may utilize one or more decisioning processes for the processing of digital payment card data as detailed herein.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

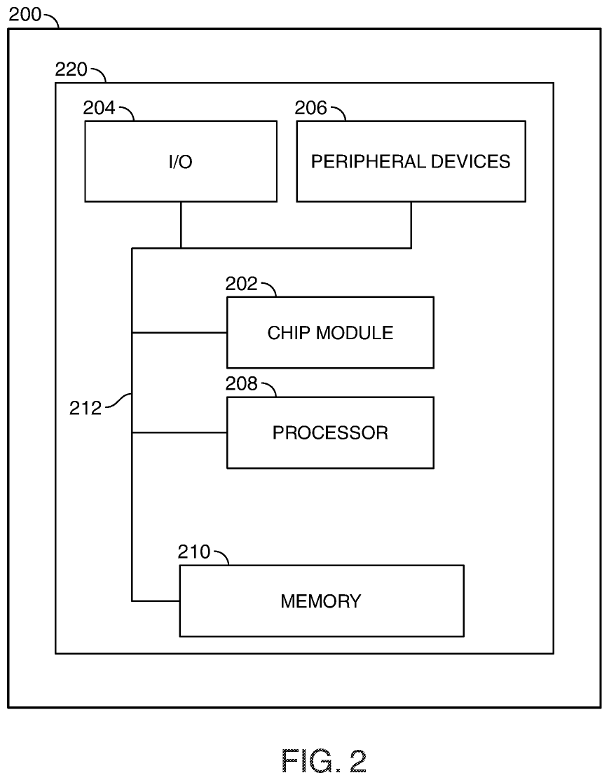

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

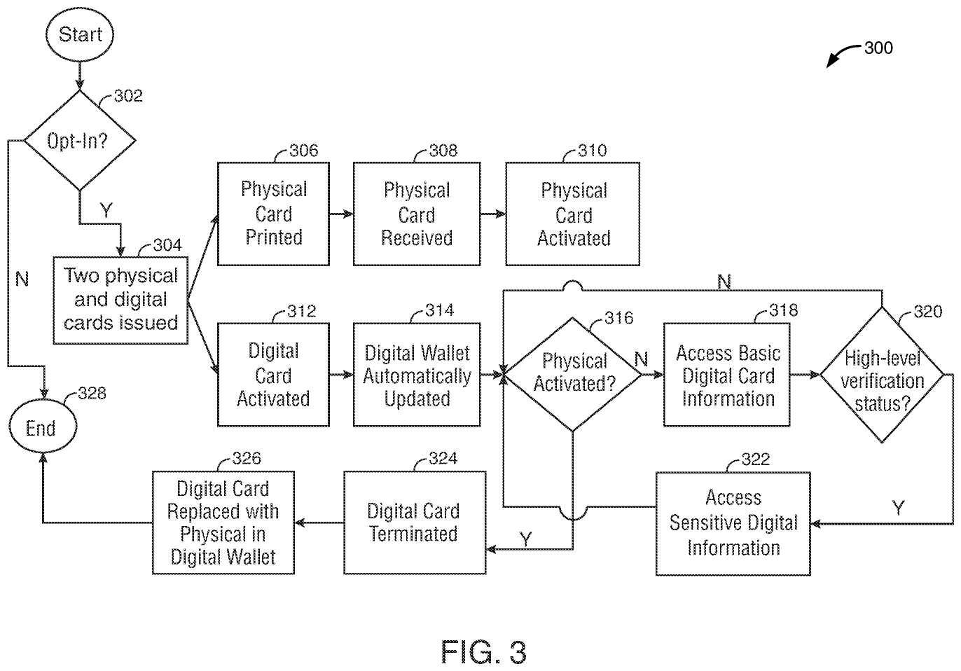

FIG. 3 shows illustrative process flow 300 for a temporary digital debit card. At 302, the system may detect a user opt in for a temporary digital debit card.

The threshold to qualify for a digital payment card may be different from the threshold to qualify for a tangible payment instrument. The qualification threshold for the digital payment card threshold may be higher than the qualification threshold for a physical payment card. Qualification for the digital payment card may require a certain credit score, a certain level of confidence of identity authentication, little or no suspicion of historical fraudulent activity, or any other suitable qualification threshold. Qualification for the digital payment card may require an issuer mobile device application. A user may be prompted to download the mobile device application in order to qualify.

A qualifying user may be offered an option to opt-in to a digital payment instrument. The option may be offered on a screen while using the mobile device applicatoin. The option may also be offered via a website, program, in person, or during the course of a telephone conversation. Selecting this option may qualify as an opt-in.

At 304, both physical and digital cards are issued. At 306, the physical payment card may be printed. At 308, the physical payment card may come into possession of the user. At 310, the physical payment card may be activated.

At 312, the digital payment card may be activated. The activation may immediately follow issuance of the card. At 314, a digital wallet may be updated with the digital payment card. The digital wallet may be part of an issuer mobile application.

At 316, the system may determine whether the physical payment card has been activated. At 318-322, the physical payment card has not yet been activated. At 318, a user may access a first subset of the digital payment card dataset. The first subset may include basic card information, such as the last four digits of a PAN. Access to the first subset may be dependent on a first level of verification.

At 318, the system may determine whether a high-level verification status has been established. A high-level verification status may be a second verification level and may require a criterion such as entry of a one-time passcode. If the second verification level has been achieved, at 322, a user may access a second subset of the dataset. The second subset may include sensitive information, such as a full 16-digit PAN, expiration date, and CVV of the digital payment instrument.

At 324, in response to a determination that the physical payment card has been activated, the digital payment card may be terminated. In some embodiments, the digital payment instrument may not be terminated, and may remain active until expiration.

At 326, the mobile application digital wallet is updated with the physical payment card. The update may be executed absent any user activity. Alternatively, the update may be executed partially or completely manually. The update may involve reprovisioning the wallet. At 328, the process may end.

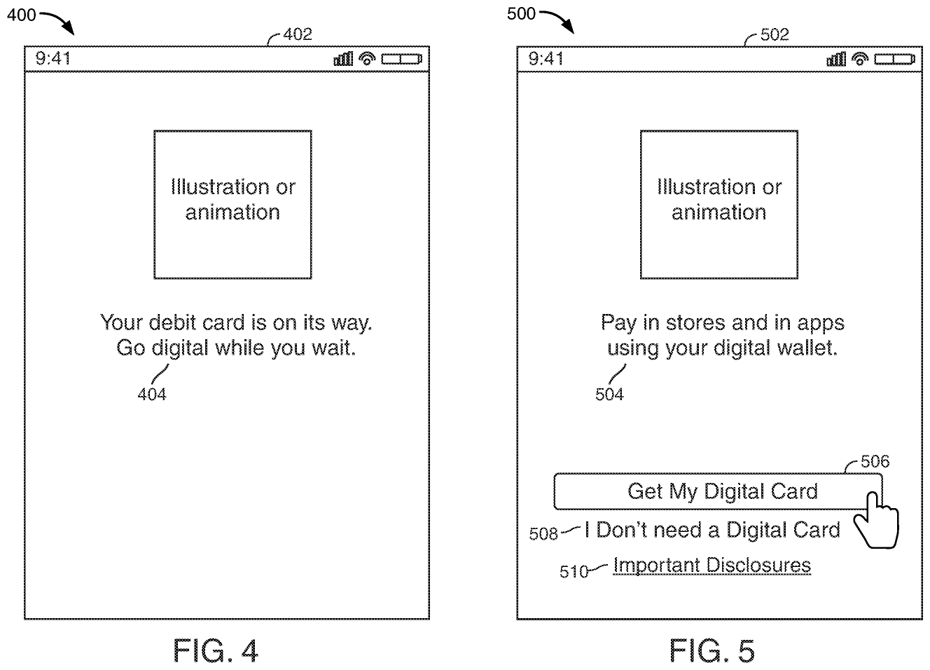

FIG. 4 shows an illustrative screen view 400. Screen 402 shows illustrative text 404 promoting a temporary digital payment card. Screen 402 may be displayed to a user who has pre-qualified for a digital debit card.

FIG. 5 shows an illustrative screen view 500. Screen 502 shows illustrative text 504 promoting a digital payment card. Screen 502 includes selectable option 506 for opting in to a digital payment card. Screen 502 includes selectable option 508 for avoiding opt in to the digital payment card. Screen 502 includes selectable option 510 for providing the user with more information about the terms and conditions of the digital payment card.

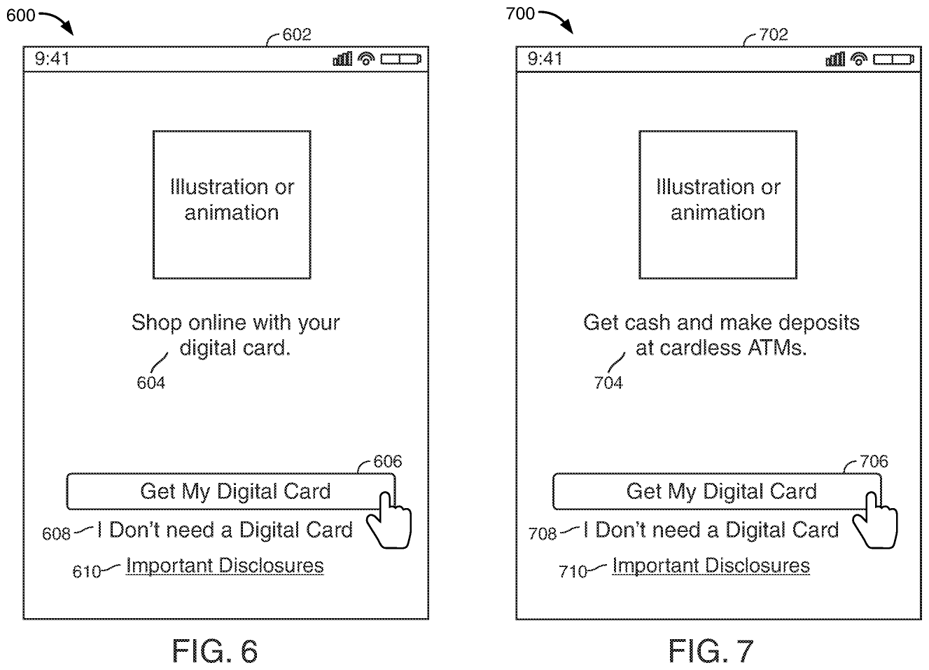

FIG. 6 shows an illustrative screen view 600. Screen 602 shows illustrative text 604 promoting a digital payment card. Screen 602 includes selectable option 606 for opting in to a digital payment card. Screen 602 includes selectable option 608 for avoiding opt in to the digital payment card. Screen 602 includes selectable option 610 for providing the user with more information about the terms and conditions of the digital payment card.

FIG. 7 shows an illustrative screen view 700. Screen 702 shows illustrative text 704 promoting a digital payment card. Screen 702 includes selectable option 706 for opting in to a digital payment card. Screen 602 includes selectable option 708 for avoiding opt in to the digital payment card. Screen 602 includes selectable option 710 for providing the user with more information about the terms and conditions of the digital payment card.

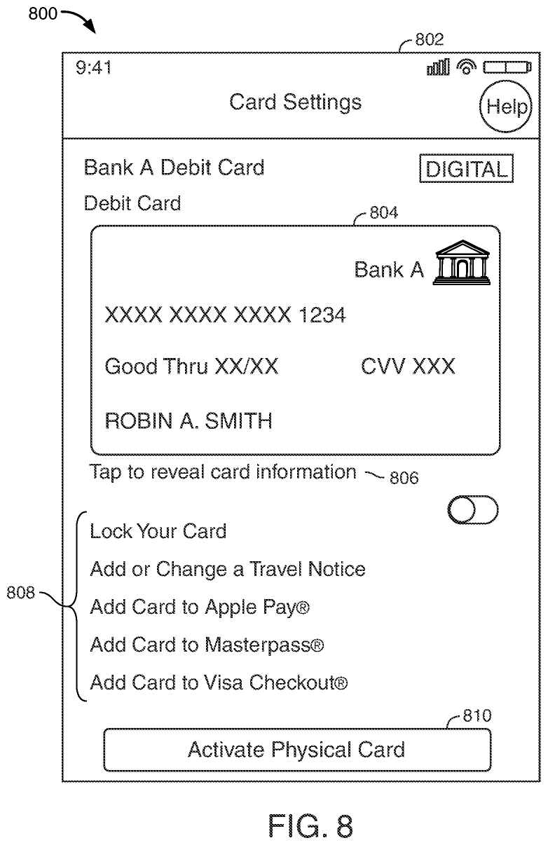

FIG. 8 shows an illustrative screen view 800. Screen 802 shows illustrative digital debit card data 804. Data 804 may include payment card information. At a first verification level, data 804 may include the last 4 digits of a PAN.

Text 806 may read “Tap to reveal card information.” Text 806 may be a selectable option. In an alternative embodiment, data 804, or any other suitable screen element, may be selectable to access more sensitive data. Sensitive data may include the full 16-digit PAN, expiration date, and CVV. The screen may only toggle to a display of the sensitive data when a high level of verification is established. Once established, the display may be toggled for the duration of a mobile application session. Selecting an option to access more sensitive data may initiate a protocol for establishing a second level of verification. For example, a temporary passcode may be created and sent to a device associated with the user.

Selectable options 810 may include an option to lock the card. Selectable options 810 may include an option to add a travel notice. Selectable options 810 may include options to add the digital debit card to various third-party digital wallets. Illustrative wallet options shown include Apple Pay™, Masterpass™, and Visa Checkout™, although any suitable digital wallet options may be provided.

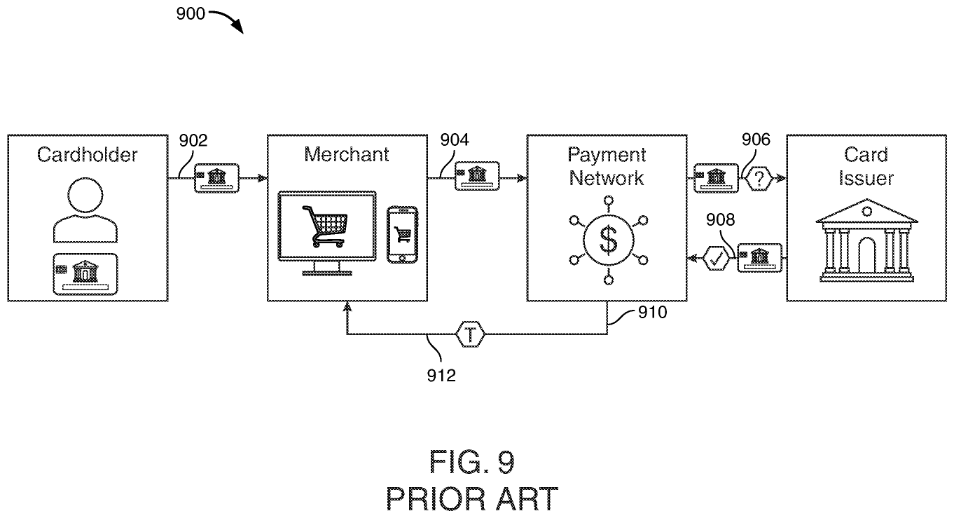

FIG. 9 shows prior art system 900 for generating a token from payment card information. At 902, the user may enter actual payment card data such as a PAN, CVV, and card expiration date at a merchant or third-party digital wallet. The merchant or third-party digital wallet may be a token requestor. At 904, the token requestor may provide the payment details to a payment network. At 906-908, the payment network may receive token approval from the card issuer. At 910, the payment network may generate a token. At 912, the payment network may provide the token to the merchant. The merchant may use the token when interacting with other transaction partners and their networks.

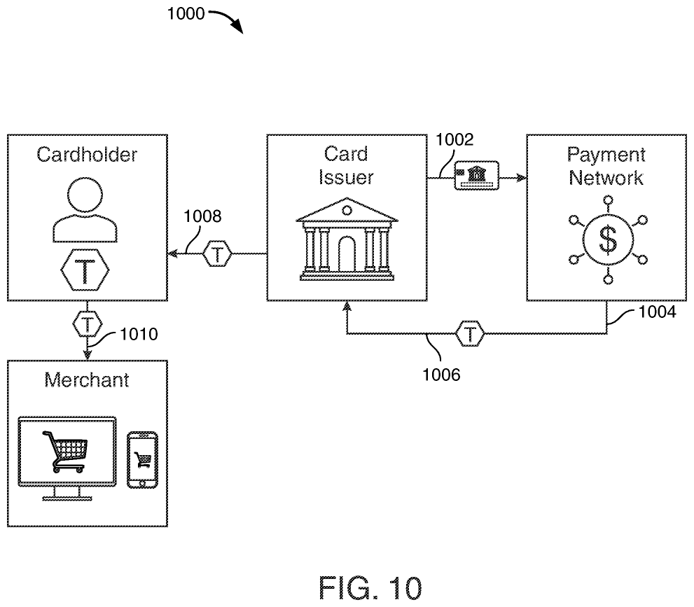

FIG. 10 shows a system where the payment card issuer is a token requestor. At 1002, the payment card issuer may provide payment card data directly to a payment network. At 1004, the payment network may issue a token. At 1006, the payment card network may provide the token to the card issuer. At 1008, the payment card issuer may issue a digital payment card to the user. Unbeknownst to the user, the digital payment card may include the token data in place of card data. At 1010, the use may execute a transaction by inputting the token data from the digital payment card.

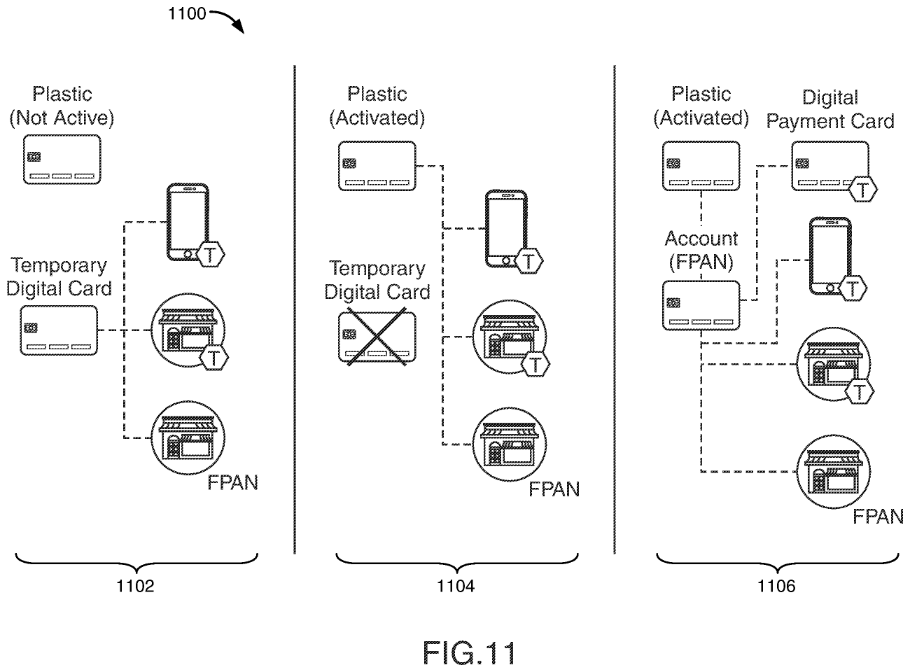

FIG. 11 shows illustrative scenarios involving a physical payment card. In scenario 1102, a temporary digital payment card is issued before the physical payment card is activated. The physical card and the temporary digital card are stored as separate, unconnected entries in an issue system of record. The user may provide the actual FPAN on the temporary digital payment card to a merchant or digital wallet. The merchant or digital wallet may subsequently obtain a token for this data.

In scenario 1104, a temporary digital payment card was issued before the physical payment card was activated. Once the plastic card is activated, the temporary digital payment card may be cancelled and the separate record for the temporary card may be deleted. The user may provide the actual FPAN on the physical payment card to a merchant or digital wallet. The merchant or digital wallet may subsequently obtain a token for this data.

In scenario 1106, the digital payment card functions independently of the physical payment card. A single record in the issuer system of record may be associated with the FPAN. The digital payment card may be generated from a token of the FPAN and then issued to a user. The digital payment card may function like a conventional card, but in fact, the user only provides the tokenized data to a merchant or digital wallet. In the event the digital card is compromised, the card data may be replaced without any changes to underlying FPAN record.

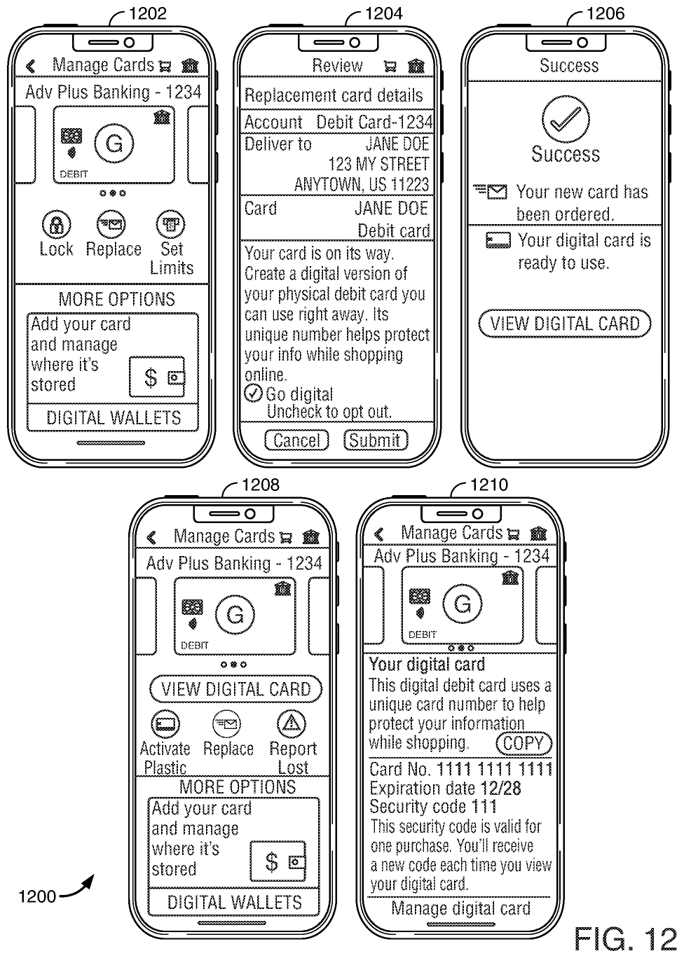

FIG. 12 shows illustrative screen views 1200 for a digital debit card that functions independently from the physical card. Screen 1202 shows an internal digital wallet in an enterprise mobile application. Screen 1202 shows a virtual representation of the physical debit card. The mobile application enables a user to lock or replace the physical card. The mobile application enables a user to set limits that will be applied to the physical card.

Screen 1204 shows an option to create a digital debit card. Screen 1206 shows that both cards have been issued and the digital card has been activated. Screen 1208 shows the digital debit card in an internal digital wallet in an enterprise mobile application. The mobile application enables a user to lock, replace, or set limits on the use of the digital card. Screen 1208 may display only a subset of the card data, such as showing a partial user account number. A user may select the “view digital card” option, shown in screen 1208. Selecting this option may allow a user to input credentials for a second level of verification.

Screen 1210 shows additional data associated with the digital debit card. Screen 1210 shows the entire 16 digit account number, the expiration date, and the security code. A user may enter this data to make a purchase. The screen also includes a selectable option to copy the card data to a merchant or digital wallet site.

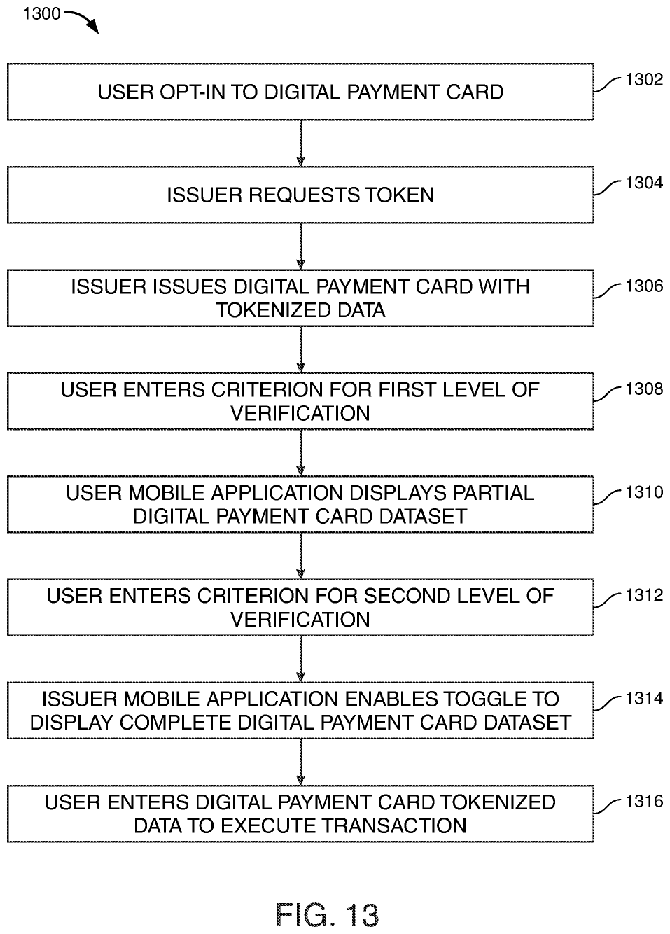

FIG. 13 shows illustrative process flow 1300 for a digital debit card that functions independently from the physical card. At step 1302, a user may opt-in for a digital payment card. At step 1304, an issuer requests a token from a payment processor for a user FPAN. At step 1306, the issuer issues a digital payment card with the tokenized data. At step 1308, the user enters a criterion for a first level of verification. At step 1310, the issuer mobile application may display a partial digital payment card dataset. At step 1312, the user enters a criterion for second level of verification. At step 1314, the issuer mobile application is enables toggling to display the complete digital payment card dataset. At step 1316, the user enters the digital payment card tokenized data to execute a transaction.

Thus, methods and apparatus for a HIGH SECURITY TOGGLE SYSTEM FOR A PAYMENT INSTRUMENT DISPLAY are provided. Persons skilled in the art will appreciate that the present invention can be practiced by other than the described embodiments, which are presented for purposes of illustration rather than of limitation. The present invention is limited only by the claims that follow.

What is claimed is:

1. A method for a high-security display of distinct subsets of a digital payment card dataset, the method comprising:
at a payment card issuer:
importing token data comprising:
a token generated from a primary account number (PAN), the token having the same number of digits as the PAN;
an expiration date associated with the token; and
a token security code associated with the token;
generating a digital payment card for a user, the digital payment card comprising the token in place of a payment card PAN, the token expiration date in place of a payment card expiration date, and the token security code in place of a payment card verification value (CVV); and
at a high security display:
in response to receiving a first signal from a user, upgrading a verification status from a default security level to a first security level;
when the verification status is at the first security level, displaying a first subset of the digital payment card dataset to the user;
in response to a second signal, upgrading the verification status from the first security level to a second security level; and
when the verification status is at the second security level, augmenting the display with a selectable option to toggle to a second subset of the dataset.

2. The method of claim 1, further comprising executing a transaction in response to receiving an input of the token, the token expiration date, and the token security code from the user.

3. The method of claim 1, wherein the token is a first token, the method further comprising, importing a second token generated from the PAN, the second token replacing the first token on the digital payment card.

4. The method of claim 3, further comprising importing the second token after a predetermined number of uses of the digital payment card.

5. The method of claim 3, further comprising importing the second token after a predetermined time period following issuance of the digital payment card.

6. The method of claim 1, wherein a plurality of tokens is associated with the PAN in a system of record maintained by the payment card issuer.

7. The method of claim 6, wherein the PAN and the tokens are maintained by the payment card issuer in the same file.

8. The method of claim 1, further comprising obtaining a new token security code for each transaction executed using the digital payment card.

9. The method of claim 1, further comprising provisioning a digital wallet with the digital payment card in response to user input of the token, the token expiration date, and the token security code.

10. The method of claim 1, further comprising automatically reprovisioning the digital wallet in response to replacing the first token with the second token.

11. One or more non-transitory computer-readable media storing computer-executable instructions which, when executed by a processor on a computer system, perform a method for a high-security display of distinct subsets of a digital payment card dataset, the digital payment card associated with a physical payment card, the physical payment card comprising a primary account number (PAN), an expiration date and a card verification value (CVV), the method comprising:
at the physical payment card issuer:
obtaining a token generated from the PAN, the token having the same number of digits as the PAN;
obtaining an expiration date associated with the token;
obtaining a token security code associated with the token, the token security code comprising a cryptogram; and
generating a digital payment card for the user, the digital payment card associated with the physical payment card and comprising the token in place of the physical payment card PAN, the token expiration date in place of the physical payment card expiration date, and the token cryptogram in place of the physical payment card CVV; and
at a high security display:
in response to receiving a first signal from a user, upgrading a verification status from a default security level to a first security level;
when the verification status is at the first security level, displaying a first subset of the digital payment card dataset to the user;
in response to a second signal, upgrading the verification status from the first security level to a second security level; and
when the verification status is at the second security level, augmenting the display with a selectable option to toggle to a second subset of the dataset.

12. The media of claim 11, further comprising executing a transaction in response to receiving an input of the token, the token expiration date, and the token cryptogram from the user.

13. The media of claim 11, wherein the token is a first token, the method further comprising, obtaining a second token generated from the PAN, the second token replacing the first token on the digital payment card.

14. The media of claim 13, further comprising obtaining the second token after a predetermined number of uses of the digital payment card.

15. The media of claim 13, further comprising obtaining the second token after a predetermined time period following issuance of the digital payment card.

16. A multiple-level verification system for display of portions of a dataset comprising sensitive digital payment card information, the system comprising:
a first processor associated with a digital payment card issuer and configured to:
obtain a token associated with a primary account number (PAN);
obtain an expiration date associated with the token;
obtain a token security code associated with the token; and
issue a digital payment card comprising the token, the expiration date for the token and the token security code; and
a second processor associated with the digital payment card issuer and configured to an authentication module configured to:
in response to a first criterion, upgrade a verification status from a default security level to a first security level;
when the verification status is at the first security level, transmit a first signal to a device to enable display of a first subset of the dataset;
in response to a second criterion, upgrade the verification status from the first security level to a second security level; and
when the verification status is at the second level, transmit a second signal to the device to enable display of a second subset of the dataset.

17. The system of claim 16, further comprising executing a transaction in response to receiving an input of the token, the token expiration date, and the token security code from the user.

18. The system of claim 16, wherein the token is a first token, the method further comprising, obtaining a second token associated with the PAN, the second token replacing the first token on the digital payment card.

19. The system of claim 18, further comprising obtaining the second token after a predetermined number of uses of the digital payment card.

20. The system of claim 18, further comprising obtaining the second token after a predetermined time period following issuance of the digital payment card.

21. The system of claim 16, further comprising obtaining a new token security code for each transaction executed using the digital payment card.

22. The system of claim 16, further comprising provisioning a digital wallet with the digital payment card in response to user input of the token, the token expiration date, and the token security code.

23. The system of claim 16, further comprising automatically reprovisioning the digital wallet in response to replacing the first token with the second token.
